(19) United States
(12) Patent Application Publication
(10) Pub. No.: US 2015/0312845 A1
(43) Pub. Date: Oct. 29, 2015

(54) METHOD AND APPARATUS FOR LOCATION-BASED SECURITY AND POLICY ENFORCEMENT FOR MOBILE DEVICES

(71) Applicant: NETLINE COMMUNICATIONS TECHNOLOGIES (N.C.T.) LTD., Tel Aviv (IL)

(72) Inventors: Benjamin TEENI, Tel Aviv (IL); Gil ISRAELI, Tel Aviv (IL); Ilan FREEDMAN, Tel Aviv (IL)

(73) Assignee: NETLINE COMMUNICATIONS TECHNOLOGIES (N.C.T.) LTD, Tel Aviv (IL)

(21) Appl. No.: 14/650,321

(22) PCT Filed: Jan. 15, 2014
(86) PCT No.: PCT/IL2014/050049

§ 371 Date: Jun. 8, 2015

Related U.S. Application Data
(60) Provisional application No. 61/752,466, filed on Jan. 15, 2013.

(51) Int. Cl. H04W 48/04; H04W 12/06; H04W 4/02

(52) U.S. Cl. CPC H04W 48/04; H04W 4/021; H04W 12/06

(57) ABSTRACT

A method of controlling a mobile device in a coverage zone, including, attracting the mobile device to form a connection to receive communication services by a managed access base station that presents itself as a base station for the coverage zone, receiving identification information from the mobile device at the managed access base station, determining if a policy client is installed on the mobile device to control use and access of resources of the mobile device, authenticating that the policy client is active on the mobile device, responsive to the authenticating enabling or preventing mobile communication services for the mobile, device.

### RELATED APPLICATIONS

This application claims priority under 35 U.S.C. 119 (e) from U.S. provisional application No. 61/752,466 filed on Jan. 15, 2013, the disclosure of which is incorporated herein by reference.

### TECHNICAL FIELD

The present disclosure relates generally to controlling the use of mobile communication devices and more specifically to enforcing policies on devices in controlled facilities and organizational campuses.

### BACKGROUND

In many situations it is desirable for an organization to limit use of mobile communication devices or specific functions of the mobile communication devices at specific locations controlled by the organization. Currently there are very few options that enable an organization to control the use of mobile communication devices in the organization's facilities. Organizations are forced to apply their policy (completely or partially) by instructing employees and visitors to use or not use the device and the device's various resources according to the policy but they have very little capability of actually enforcing the policy. This is due to the fact that many of the services are provided by networks and devices that are out of the organization's control.

Some organizations prohibit entry with mobile communication devices or only allow entry with mobile communication devices on which a policy client application is installed. The policy client that is installed on the controlled device is used to enforce the policy of the organization. Nevertheless, such solutions fall-short in the sense that they are unable to limit/control devices and users who managed to enter without installing the policy client on their device or if the user or another application have removed/disabled the policy client. Examples of this type of solution can be found in the article published by W. Jansen and V. Korolev: “A Location-Based Mechanism for Mobile Device Security” (2009). Commercial Solutions of this type include the likes of CELLUSEC by Wisesec and AFARIA by SAP.

Another solution is the installation of a base station that serves as a honeypot drawing the mobile communication devices to communicate through the organization base station when they are at the premises of the organization. The organization base station can then keep the devices attached and deny them service or provide limited service based on the organization policy. A problem with this solution relative to the policy client is that it can only control communications to or from the device but not applications running on the device. Thus for example this solution can either allow a user to communicate or not but cannot enforce rules such as allowing a specific application, to run or prevent use of a specific element of the mobile device such as a camera.

### SUMMARY

An aspect of an embodiment of the disclosure relates to a system and method for controlling activity and/or communications of mobile devices in a coverage zone that is in an area controlled by an organization. A managed access base station (MABS) is installed at the location of the organization to present itself as a base station providing mobile communication services to mobile devices in the coverage zone. A mobile device requesting communication services in the coverage zone will automatically be connected to the managed access base station instead of a standard commercial base station. The managed access base station will initially keep the mobile device on hold preventing it from using mobile communications. The managed access base station will collect the identity information of the mobile device and/or information of the user of the device. Then the managed access base station will check if the mobile device has a policy client application installed on it and the managed access base station will authenticate the validity of the policy client.

Once the policy client is authenticated the managed access base station may provide the policy client with an access policy defining rules relating to use and access to applications and devices of the mobile device, for example times and locations in the coverage zone where the camera, telephone and/or Internet will be enabled or disabled. Once the policy client applies the access policy the managed access base station will allow it to communicate either by providing communication through the managed access base station or by releasing the mobile device so that it will connect through a standard commercial base station with an activated policy client.

In an exemplary embodiment of the disclosure, the policy client may be updated with a new access policy periodically or when moving from one location to another. Alternatively, the policy client can update the policy by itself based on rules provided in the access policy provide by the managed access base station. Optionally, when leaving the coverage zone the managed access base station will release the mobile device so that it will connect through a standard commercial base station and the policy client will also cancel any restrictions applied.

In an exemplary embodiment of the disclosure, a mobile device without a policy client or with a policy client that fails authentication will be kept on hold to prevent them from forming communications with another base station. Alternatively or additionally, the managed access base station will provide it with limited communication ability based on a policy of the organization.

There is thus provided according to an exemplary embodiment of the disclosure, a method of controlling a mobile device in a coverage zone, comprising:

Attracting the mobile device to request to form a connection to receive communication services by a managed access base station that presents itself as a base station for the coverage zone;

Receiving identification information from the mobile device at the managed access base station;

Determining if a policy client is installed on the mobile device to control use and access of resources of the mobile device;

Authenticating that the policy client is active on the mobile device; Responsive to said authenticating enabling or preventing mobile communication services for the mobile device.

In an exemplary embodiment of the disclosure, the mobile device is accepted to form a connection to receive communication services by the managed access base station before authenticating yet is not provided with communication services before being authenticated. Optionally, if authenticating that the policy client is active on the mobile device fails the managed access base station will keep the mobile device captive preventing mobile communication services or enabling limited mobile communication services. Alternatively, if authenticating that the policy client is active on the mobile device succeeds the managed access base station will keep the mobile device captive enabling the mobile device to communicate freely or selectively through the managed access base station and limited by the control of the policy client. Further alternatively, if authenticating that the policy client is active on the mobile device succeeds the managed access base station will release the connection with the mobile device so that it will connect with a standard commercial base station to receive communication services limited by the control of the policy client.

In an exemplary embodiment of the disclosure, if the authenticating that the policy client is active on the mobile device fails the mobile device is accepted to form a connection to receive communication services by the managed access base station to prevent or limit communication services by receiving communication services from a commercial base station. Optionally, if the authenticating that the policy client is active on the mobile device succeeds the mobile device is not accepted to form a connection to receive communication services by the managed access base station thereby forcing the mobile device to remain connected to a commercial base station so that the mobile device will receive communication services limited by the control of the policy client from the commercial base station.

In an exemplary embodiment of the disclosure, if authenticating succeeds then defining an access policy by a policy management server to be applied on the mobile device by the policy client; applying the access policy by the policy client; and then enabling mobile communication services for the mobile device. Optionally, the policy client communicates with the policy management server using WiFi.

In an exemplary embodiment of the disclosure, the managed access base station monitors the location of the mobile device. Optionally, the policy client in the mobile device monitors the location of the mobile device. In an exemplary embodiment of the disclosure, the policy client applies a different access policy at different locations in the coverage zone. Optionally, the policy client cancels access policy restrictions upon leaving the coverage zone. In an exemplary embodiment of the disclosure, the access policy is updated responsive to temporal information.

There is further provided according to an exemplary embodiment of the disclosure a system for controlling a mobile device in a coverage zone, comprising:

A managed access base station that a presents itself as a base station for the coverage zone;

A policy client that is installed on the mobile device to control use and access of resources of the mobile device;

Wherein the managed access base station is configured to perform the following:

Attracting the mobile device to request to form a connection to receive communication services by the managed access base station that presents itself as a base station for the coverage zone;

Receiving identification information from the mobile device at the managed access base station;

Determining if the policy client is installed on the mobile device to control use and access of resources of the mobile device;

Authenticating that the policy client is active on the mobile device; Responsive to the authenticating enabling or preventing mobile communication services for the mobile device.

In an exemplary embodiment of the disclosure, the mobile device is accepted to form a connection to receive communication services by the managed access base station before authenticating yet is not provided with communication services before being authenticated. Optionally, if authenticating that the policy client is active on the mobile device fails the managed access base station will keep the mobile device captive preventing mobile communication services or enabling limited mobile communication services. Alternatively, if authenticating that the policy client is active on the mobile device succeeds the managed access base station will keep the mobile device connected enabling the mobile device to communicate freely or selectively through the managed access base station and limited by the control of the policy client. Further alternatively, if authenticating that the policy client is active on the mobile device succeeds the managed access base station will release the connection with the mobile device so that it will connect with a standard commercial base station to receive communication services limited by the control of the policy client.

In an exemplary embodiment of the disclosure, if the authenticating fails the mobile device is accepted to form a connection to receive communication services by the managed access base station to prevent or limit communication services. Alternatively, if the authenticating succeeds the mobile device is not accepted to form a connection to receive communication services by the managed access base station so that the mobile device will be enabled to receive communication services limited by the control of the policy client by connecting with a standard commercial base station.

In an exemplary embodiment of the disclosure, if authenticating succeeds: defining an access policy by a policy management server to be applied on the mobile device by the policy client; applying the access policy by the policy client; and then enabling mobile communication services for the mobile device.

In an exemplary embodiment of the disclosure, the system further comprises a policy management server for defining an access policy to be applied on the mobile device by the policy client. Optionally, the policy client communicates with the policy management server using WiFi.

### BRIEF DESCRIPTION OF THE DRAWINGS

The present disclosure will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of a system for managing mobile devices in a coverage zone, according to an exemplary embodiment of the disclosure; and

FIG. 2 is a flow diagram of a method 200 of policy enforcement for mobile devices in a coverage zone, according to an exemplary embodiment of the disclosure.

### DETAILED DESCRIPTION

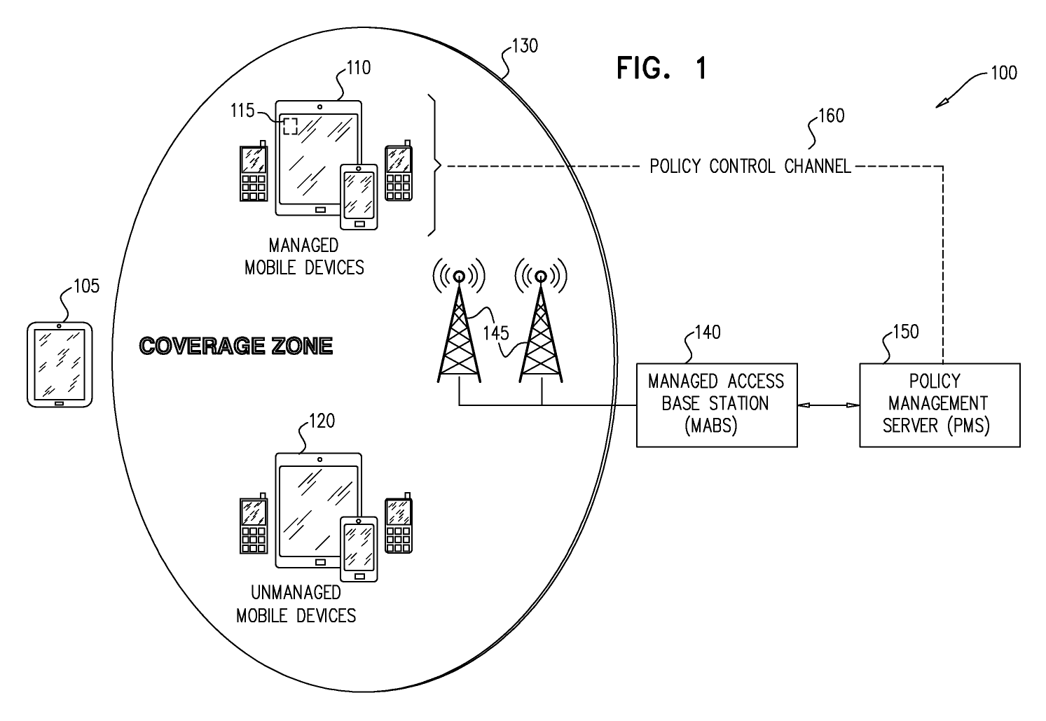

FIG. 1 is a schematic illustration of a system 100 for managing mobile devices 110 in a coverage zone 130, according to an exemplary embodiment of the disclosure. In an exemplary embodiment of the disclosure, system 100 enforces a policy on managed mobile devices 110 that include a policy client 115 installed on them to enforce the policy. Additionally, system 100 limits or denies service for unmanaged mobile devices 120 that do not have a policy client 115 installed on them. In an exemplary embodiment of the disclosure, system 100 includes a managed access base station (MABSS) 140. Managed access base station 140 serves as a base station providing service to a coverage zone 130. Managed access base station 140 attracts mobile devices 105 that enter coverage zone 130 forming communication sessions with the mobile devices 105. In an exemplary embodiment of the disclosure, mobile devices 105 are either managed mobile devices 110 or unmanaged mobile devices 120. Optionally, managed access base station 140 collects identity information from mobile devices 105 in the coverage zone 130 and keeps them connected either providing communication services or keeping them on hold to prevent them from accessing other base stations. Generally the other base stations will have a weaker signal than managed access base station 140 in the coverage zone so that they will connect to managed access base station 140. However other methods known in the art may be used to assure that mobile devices 105 in the coverage zone 130 connect to managed access base station 140 and not to other base stations. In an exemplary embodiment of the disclosure, the coverage zone 130 may be a room, a building, an estate, a campus with one or more buildings, a factory, an army base or any other area. Optionally, managed access base station 140 includes one or more transceivers 145 to service the coverage zone 130 with adequate transmission and reception.

In an exemplary embodiment of the disclosure, a policy management server (PMS) 150 is connected to managed access base station 140 to define access policies for managed mobile devices 110 and to authenticate such devices.

In an exemplary embodiment of the disclosure, a mobile device 105 that enters coverage zone 130 is identified by managed access base station 140. Optionally, managed access base station 140 communicates with the mobile device 105 and acquires the mobile device as a subscriber preventing it from accessing other base stations (e.g. commercial base station). In an exemplary embodiment of the disclosure, managed access base station 140 collects from the mobile device 105 identity information, for example MAC address, international mobile subscriber identity (IMSI) and/or international mobile station equipment identity (IMEI). Optionally, policy management server 150 receives the identity information and authenticates the mobile device 105.

In an exemplary embodiment of the disclosure, unmanaged mobile devices 120, for example standard mobile devices 105 that do not have a policy client 115 installed will be denied service or provided with limited service, for example only allowed to receive calls but not initiate calls. Optionally, mobile devices 105 may be pre-registered with policy management server 150 so that unmanaged mobile devices 120 that are pre-registered may be allowed one level of service, whereas unmanaged mobile devices that are not pre-registered will be allowed a lower level of service, for example pre-registered unmanaged mobile devices 120 may be allowed to initiate and accept calls but prevented from sending SMS messages, whereas unmanaged mobile devices 120 that are not pre-registered are denied service while in the coverage zone 130.

In contrast managed mobile devices 110 with the client policy 115 installed will be authenticated by policy management server 150 and will be allowed services based on the policy of the organization and their location in the facilities of the organization, for example in one building they may be allowed to place calls and access the Internet whereas in another building only access the Internet. Optionally, the authentication may be a two factor authentication, for example authenticating the identity of the managed mobile device 110 and the identity of the user (e.g. by requesting that the user enter a password). In some embodiments of the disclosure, policy client 115 is a software application installed on the managed mobile device 110 or policy client 115 may be hardwired or provided as a permanent application to prevent it from being removed by the user or by other applications.

In some embodiments of the disclosure, policy client 115 forms contact with policy management server 150 via managed access base station 140. Alternatively, once a managed mobile device 110 forms contact with managed access base station 140 it performs authentication with policy management server 150 through other channels 160, such as Wi-Fi, or other communication methods that are available at the premises of the organization. In some embodiments of the disclosure, managed mobile device 110 may disconnect from managed access base station 140 as explained below yet policy client 115 may continue to communicate directly or indirectly with policy management server 150 via the Internet for example using cellular 3G/4G/GPRS/LTE or other methods.

Optionally, once managed mobile device 110 is authenticated, policy management server 150 generates a policy for managed mobile device 110. The policy includes a set of rules to be applied to managed mobile device 110 and its resources. In an exemplary embodiment of the disclosure, the policy may be based on various parameters, such as:

1. The type of mobile communication device;

2. Identity of the user of the device;

3. Device location in the premises of the organization;

4. Temporal information such as time of day, day of the week, date; and

5. Other external parameters such as level of alert currently implemented at the organization, for example standard alert or high alert wherein access may be more limited.

In an exemplary embodiment of the disclosure the policy may control use and/or access to any resource of the managed mobile device 110, including:

1, Cellular voice and data communications;

2. Wi-Fi communications;

3. Use of applications on the device;

4. GPS/location services;

5. Camera;

6. Bluetooth; and

7. Other elements or applications available on managed mobile device 110.

In an exemplary embodiment of the disclosure, policy management server 150 sends policy client 115 of managed mobile device 110 a defined policy based on the details as explained above. Policy client 115 applies the policy in managed mobile device 110. Optionally, managed mobile device 110 notifies policy management server 150 that the policy has been applied in managed mobile device 110 so that policy management server 150 can instruct managed access base station 140 to enable unrestricted or less restricted communications for managed mobile device 110. In some embodiments of the disclosure, this is implemented by rejecting the connection of managed mobile device 110 to managed access base station 140 so that managed mobile device 110 will connect to a standard commercial network instead of being trapped by managed access base station 140. Alternatively, managed access base station 140 is configured to provide service as a real base station. The provision of communication services via managed access base station 140 is performed by standard methods or as described in provisional application No. 61/735,017 filed on Dec. 9, 2012 the disclosure of which is incorporated herein by reference.

In an exemplary embodiment of the disclosure, managed access base station 140 may only interrogate mobile device 105 to acquire its identity information and only accept it for communication if it is an unmanaged mobile device 120 to prevent it from communicating. Optionally, a managed mobile device 110 will not be connected to managed access base station 140 but will communicate with policy management server 150 via the Internet to accept policy instructions.

In an exemplary embodiment of the disclosure, the position of a mobile device 105 is determined by managed access base station 140, for example to determine if the mobile device should be connected to managed access base station 140 or ignored, for example if mobile device 105 is outside coverage zone 130 (e.g. outside a building of the organization) then it should be ignored. Whereas if mobile device 105 is inside coverage zone 130 (e.g. inside a building of the organization) then it should be handled by managed access base station 140. Optionally, the position is determined based on one or more other methods know in the art, such as using Wi-Fi access points, Bluetooth transmitters as radio beacons, having policy client 115 measure the signal from such beacons located in the facility to determine location by proximity to specific beacons, or by other means such as GPS location information and any other signal that could be received/detected by mobile device 105 when the mobile device 105 is near or inside the coverage zone 130. In some embodiments of the disclosure, the policy for handling mobile device 105 (managed 110 or unmanaged 120) may vary dynamically depending on the exact location of the device, for example specific locations (e.g. buildings, rooms) in the organization may require a higher level of security than other locations in the organization. Optionally managed mobile device 110 may update policy management server 150 periodically with its location so that policy management server 150 can dynamically notify managed mobile device 110 with updates of the policy. In some embodiments of the disclosure, managed access base station 140 may query unmanaged mobile devices 120 periodically to receive an update regarding the location of the device and likewise update the implemented policy if necessary.

In an exemplary embodiment of the disclosure, when mobile device 105 leaves the coverage zone 130 of the organization, managed access base station 140 releases the connection with mobile device 105 so that it will connect to standard commercial networks. If a managed mobile device 110 was already released and its policy client 115 applied restrictions then policy client 115 cancels the restrictions and returns managed mobile device 110 to normal operation. In some embodiments of the disclosure, during the initial authentication, policy client 115 of managed mobile device 110 receives the boundaries of coverage zone 130. Alternatively, policy client 115 may query managed access base station 140, for example when the user changes his or her location to determine if its current location is within the coverage zone 130.

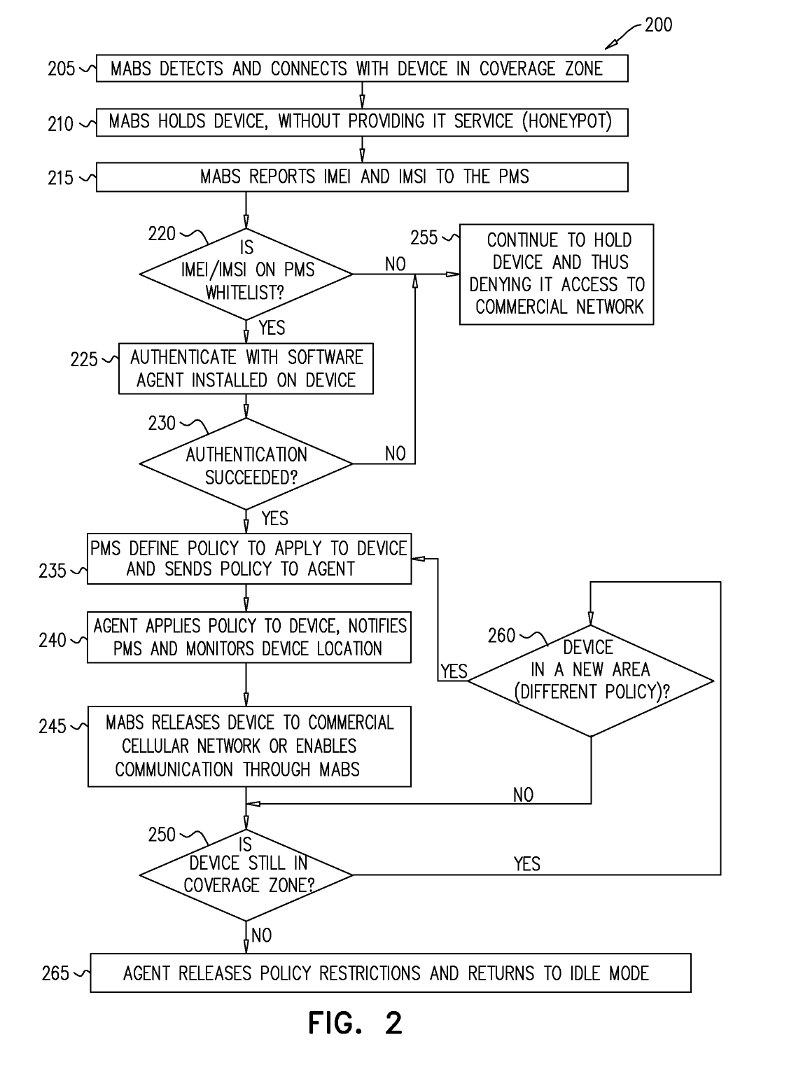

FIG. 2 is a flow diagram of a method 200 of policy enforcement for mobile devices 105 in a coverage zone 130, according to an exemplary embodiment of the disclosure. In an exemplary embodiment of the disclosure, managed access base station 140 detects and communicates (205) with mobile device 105 in coverage zone 130. Optionally, managed access base station 140 holds (210) mobile device 105 without providing it service (e.g. like a honeypot system). Managed access base station 140 accepts identity information of the device and/or user from mobile device 105 and reports (215) the information to policy management server 150. Policy management server 150 checks (220) if the identity information is recorded in a white-list, identifying it as a known mobile device 105 that should be provided with a specific level of service or that the mobile device 105 is a managed mobile device 110 with a policy client 115 installed.

In an exemplary embodiment of the disclosure, if mobile device 105 is identified as having a policy client 115 installed, then managed access base station 140 attempts to authenticate (225) with the software installed on the mobile device 105. If (230) authentication fails or the device is unknown to managed access base station 140 then managed access base station 140 continues to hold (255) the mobile device 105 thus denying it access to a commercial network to receive service. Optionally, policy management server 150 may differentiate between devices that were pre-registered but don't have a policy client 115 installed and devices that are completely unknown to it. Policy management server 150 may allow managed access base station 140 to provide limited service of different levels to registered and unregistered mobile devices respectively.

If authentication of managed mobile device 110 succeeds then policy management server 150 defines (235) a policy for applying on managed mobile device 110 with a policy client 115 installed. Policy management server 150 sends the policy to policy client 115. Optionally, policy client 115 applies (240) the policy and notifies policy management server 150 that policy client 115 is in control. Additionally, policy client 115 monitors the location of the device to correctly implement the policy based on the location in coverage zone 130. In some embodiments of the disclosure, the policy may be location dependent allowing different functions in different locations, for example allowing managed mobile device 110 to take pictures only in specific rooms or buildings.

In an exemplary embodiment of the disclosure, managed access base station 140 releases (245) managed mobile device 110 to connect with a commercial base station and monitor itself using policy client 115 or managed access base station 140 may enable full communication access since managed mobile device 110 is monitoring itself. If managed mobile device 110 changes (260) its location it can either communicate with policy management server 150 to receive a new policy or it may update the policy on its own based on the rules provided in the initial policy. If however managed device 110 leaves (250) the coverage zone 130 then policy client 115 will cancel (265) the policy restrictions and/or notify managed access base station 140 to release managed mobile device 110 so that it can connect to a commercial unrestricted base station.

In some embodiments of the disclosure during authentication mobile device 105 is denied service until policy management server 150 determines if the mobile device 105 is managed or unmanaged and applies a policy. Optionally, this time is very short and unnoticeable to the user. Alternatively, managed access base station 140 or a standard commercial base station may provide full service for the short time during, which policy management server 150 determines how the mobile device 105 should be handled.

In some embodiments of the disclosure, policy management server 150 and managed access base station 140 are implemented by general purpose computers having a processor and memory and with a software application installed and executed therein. Optionally, both may be implemented by a single computer or by multiple computers or by other dedicated hardware.

In some embodiments of the disclosure, system 100 is applicable to Wi-Fi communication systems.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure. It will also be appreciated by persons skilled in the art that the present disclosure is not limited to what has been particularly shown and described hereinabove.

I/we claim:

1. A method of controlling a mobile device in a coverage zone, comprising:
attracting the mobile device to request to form a connection to receive communication services by a managed access base station that presents itself as a base station for the coverage zone;
receiving identification information from the mobile device at the managed access base station;
determining if a policy client is installed on the mobile device to control use and access of resources of the mobile device;
authenticating that the policy client is active on the mobile device;
responsive to said authenticating enabling or preventing mobile communication services for the mobile device.

2. The method of claim 1, wherein the mobile device is accepted to form a connection to receive communication services by the managed access base station before authenticating yet is not provided with communication services before being authenticated.

3. The method of claim 2, wherein if authenticating that the policy client is active on the mobile device fails the managed access base station will keep the mobile device captive preventing mobile communication services or enabling limited mobile communication services.

4. The method of claim 2, wherein if authenticating that the policy client is active on the mobile device succeeds the managed access base station will keep the mobile device captive enabling the mobile device to communicate freely or selectively through the managed access base station and limited by the control of the policy client.

5. The method of claim 2, wherein if authenticating that the policy client is active on the mobile device succeeds the managed access base station will release the connection with the mobile device so that it will connect with a standard commercial base station to receive communication services limited by the control of the policy client.

6. The method of claim 1, wherein if the authenticating that the policy client is active on the mobile device fails the mobile device is accepted to form a connection to receive communication services by the managed access base station to prevent or limit communication services by receiving communication services from a commercial base station.

7. The method of claim 1, wherein if the authenticating that the policy client is active on the mobile device succeeds the mobile device is not accepted to form a connection to receive communication services by the managed access base station thereby forcing the mobile device to remain connected to a commercial base station so that the mobile device will receive communication services limited by the control of the policy client from the commercial base station.

8. The method of claim 1, wherein if authenticating succeeds:
defining an access policy by a policy management server to be applied on the mobile device by the policy client;
applying the access policy by the policy client; and
then enabling mobile communication services for the mobile device.

9. The method of claim 8, wherein said policy client communicates with the policy management server using WiFi.

10. The method of claim 1, wherein said managed access base station monitors the location of the mobile device.

11. The method of claim 1, wherein said policy client in the mobile device monitors the location of the mobile device.

12. The method of claim 1, wherein said policy client applies a different access policy at different locations in the coverage zone.

13. The method of claim 1, wherein said policy client cancels access policy restrictions upon leaving the coverage zone.

14. The method of claim 1, wherein said access policy is updated responsive to temporal information.

15. A system for controlling a mobile device in a coverage zone, comprising:
a managed access base station that that presents itself as a base station for the coverage zone;
a policy client that is installed on the mobile device to control use and access of resources of the mobile device;
wherein said managed access base station is configured to perform the following:
attracting the mobile device to request to form a connection to receive communication services by the managed access base station that presents itself as a base station for the coverage zone;
receiving identification information from the mobile device at the managed access base station;
determining if the policy client is installed on the mobile device to control use and access of resources of the mobile device;
authenticating that the policy client is active on the mobile device;
responsive to said authenticating enabling or preventing mobile communication services for the mobile device.

16. The system of claim 15, wherein the mobile device is accepted to form a connection to receive communication services by the managed access base station before authenticating yet is not provided with communication services before being authenticated.

17. The system of claim 16, wherein if authenticating that the policy client is active on the mobile device fails the managed access base station will keep the mobile device captive preventing mobile communication services or enabling limited mobile communication services.

18. The system of claim 16, wherein if authenticating that the policy client is active on the mobile device succeeds the managed access base station will keep the mobile device connected enabling the mobile device to communicate freely or selectively through the managed access base station and limited by the control of the policy client.

19. The system of claim 16, wherein if authenticating that the policy client is active on the mobile device succeeds the managed access base station will release the connection with the mobile device so that it will connect with a standard commercial base station to receive communication services limited by the control of the policy client.

20. The system of claim 15, wherein if the authenticating fails the mobile device is accepted to form a connection to receive communication services by the managed access base station to prevent or limit communication services.

21. The system of claim 15, wherein if the authenticating succeeds the mobile device is not accepted to form a connection to receive communication services by the managed access base station so that the mobile device will be enabled to receive communication services limited by the control of the policy client by connecting with a standard commercial base station.

22. The system of claim 15, wherein if authenticating succeeds:
defining an access policy by a policy management server to be applied on the mobile device by the policy client;
applying the access policy by the policy client; and
then enabling mobile communication services for the mobile device.

23. The system of claim 15, further comprising a policy management server for defining an access policy to be applied on the mobile device by the policy client.
